(19) United States
(12) Patent Application Publication
(10) Pub. No.: US 2003/0179717 A1
(43) Pub. Date: Sep. 25, 2003

(54) Methods and apparatus for controlling multi-layer communications networks

(76) Inventors: Christopher W. L. Hobbs, Ottawa (CA); John H. Bell, Ottawa (CA)

Correspondence Address: NORTEL NETWORKS LIMITED, P. O. BOX 3511, STATION C, OTTAWA, ON, K1Y 4H7, CA

(21) Appl. No.: 10/391,576

(22) Filed: Mar. 20, 2003

Related U.S. Application Data
(63) Continuation-in-part of application No. 09/438,517, filed on Nov. 12, 1999, now abandoned.

(30) Foreign Application Priority Data
Sep. 27, 1999 (CA) 2,283,607

(51) Int. Cl. H04L 12/28; G01R 31/08; G08C 15/00; H04L 12/26; G06F 11/00; H04J 3/14; H04J 1/16; H04L 1/00

(52) U.S. Cl. 370/254; 370/252

(57) ABSTRACT

In methods and apparatus for controlling multi-layer communications networks, data characterizing activity and state of the network and external demands made on the network by customer requests at at least two Layers is collected. The collected data are processed in accordance with a dynamic policy to determine that a reconfiguration of at least one Layer of the at least two Layers is favourable, and to determine a favoured reconfiguration of the at least one Layer. The collected data are processed in accordance with a dynamic policy to determine a favoured selection of customer demands on the network to be accepted. Implementation of the favoured reconfiguration and favoured admission is initiated. The resulting network behaviour is observed and the dynamic policy is adjusted to increase its ability to find favourable reconfiguration and call admission actions. The Layers may, for example, be a Layer 3 packet data service, such as Internet Protocol service, and layers below Layer 3 including one or more Layer 2 path-oriented service and one or more Layer 1 transport services. The reconfiguration of all Layers depends on information received from all Layers. Rapid reconfiguration of the Layer 2 and Layer 1 equipment and rapid decisions on the acceptance or rejection of customer demands based on data collected from all Layers reduces over-provisioning of the network needed to meet difficult-to-predict traffic patterns and loss of revenue due to inability to serve traffic with the current network configuration. A Fuzzy Logic control algorithm with policy tuning by temporal difference Reinforcement algorithms is described.

This application is a continuation-in-part of U.S. patent application Ser. No. 09/438,517 filed Nov. 12, 1999.

### FIELD OF INVENTION

This invention relates generally to methods and apparatus for controlling communications networks, and more particularly to methods and apparatus for controlling communications networks, which provide services at several layers.

### BACKGROUND OF INVENTION

Providers of network services often provide services at more than one Layer. For example, a Service Provider may offer IP services at Layer 3, connexion-oriented services at Layer 2 and optical services at Layer 1. Typically a network operator will offer services at more than one Layer: for example, IP (Layer 3), MPLS (Layer 2), ATM (Layer 2), Wavelength (Layer 1) and Fibre (Layer 1) services. The customer will choose one or more of these services depending on his particular needs.

All of these may compete dynamically for the same optical resources (fibres, WDM paths, etc). This produces contention for lower Layer resources between demands made by services at the lower Layer and demands made by higher Layer services. To handle this contention, it is necessary to reconfigure Layer 1 and Layer 2 from time to time in order to improve the Layer 1, Layer 2 and Layer 3 performance and often this reconfiguration is carried out manually. Such manual reconfiguration may need to be performed daily by some Internet Service Providers (ISPs).

Each manual reconfiguration requires the time and considerable skill of one or more network operators who need a good intuitive understanding of the network and its operation. The growing size and complexity of networks providing, in particular, Layer 1, Layer 2 and Layer 3 services, the growing dynamic behaviour, quantity and unpredictability of the traffic they carry and the increasing agility in the network components themselves tax the network operators' skills, their understanding of the network and its operation, and their ability to keep pace with the need for required reconfigurations. Moreover, the results of the manual reconfigurations vary considerably from network operator to network operator, and are generally suboptimal. Furthermore, the demand for skilled network operators outstrips their availability in the marketplace.

One technique currently applied to this problem is to allow a higher Layer to demand resources from the lower Layers automatically as the traffic on the higher Layer network changes. (see, for example, European Patent Application EP1003348A2: “Telecommunications Network with a Transport Layer Controlled by an Internet Protocol Layer”) Placing a controlling function in one Layer such as this is inadequate whenever a network provider offers customers services at more than one network Layer. In that case, this technique of “control from above” does not allow an optimal solution to be found: the anticipated rewards from using a lower Layer resource for demands at the lower Layer or using the lower Layer resource to meet demands from the higher Layer cannot be resolved.

As will be seen further below, improvements can be made to perform much of the reconfiguration task automatically.

A technique that can be applied is that of Reinforcement Learning. Reinforcement Learning is a well-known technique relying on taking actions and observing the reward (or “Reinforcement”) which results and adjusting future actions in accordance with that reward. This reward may be represented by a continuous value, in practice discretised by a conventional computer representation of a real number, or may have discrete states. Adjusting future actions can be achieved using the technique of Temporal Difference. Temporal Difference was proposed to solve Long-Delay Problems—where a system's behaviour depends not on the immediate control signals but on a combination of historical control signals.

The use of these techniques requires an approximation to a scalar function V(s₁, S₂, . . . , s_{N}) for some dimension N. In principle this functional approximator may be held as a table but the large dimension (N), sometimes as large as 90, renders this impossible in practice. Instead one can use a CMAC as a multi-dimensional functional approximator.

Even using CMACs, the problem of dimensionality is difficult to handle, requiring extensive learning before the high-dimensional space is sufficiently populated to allow accurate assessments to be made. A further step can made by applying Fuzzy rather than Crisp variables to the CMAC.

The techniques of Fuzzy Logic are well-known and the combination of Reinforcement Learning with the representation of state and demand as Fuzzy Logic variables offers stable control for non-stationary systems that are ill-defined such as multi-layer telecommunications networks. Rapid and coordinated reconfiguration of the network Layers according to Network State reduces over-provisioning of the network needed to meet difficult-to-predict traffic patterns and loss of revenue due to inability to serve traffic with the current network configuration. This saving arises because, with higher-level services, for example Layer 3 services, such as Internet Protocol (IP) services, revenue increases approximately linearly with the number of subscribers served whereas network costs increase approximately as the square of the number of subscribers served. This pattern is unlike the corresponding pattern for voice services in which traffic patterns are predictable enough to permit a network hierarchy that enables network costs to grow sub linearly as the number of subscribers grows. In addition, the demand made by any single voice customer is for an insignificant amount of network resource. This is not the case for data services where a customer demand, particularly at Layer 1 or Layer 2, may be for a significant amount of resource. IP networks are made essentially “flat” (i.e. without hierarchy) because the traffic patterns are not so readily predicted or as geographically focused as voice traffic, so costs will go up as the square of the number of subscribers served unless the network is reconfigured in response to observed traffic. The faster and more accurately this reconfiguration can be tailored to traffic patterns, the less over provisioning is needed to avoid losing revenue due to lost traffic, or the more traffic can be served at a given level of over provisioning for more revenue. Collection of data from the at least two network Layers and processing it together permits more accurate tailoring of the reconfiguration to the traffic patterns.

### SUMMARY OF INVENTION

This invention seeks to reduce or eliminate the problems of manual reconfiguration of networks comprising at least two Layers as outlined above while allowing the network provider to offer economic service to customers at each of the at least two Layers.

It does this by providing a controller, independent of the switching devices to each of the at least two Layers, which receives Network State information. It processes this information and makes a decision about advantageous Network Adjustments.

One aspect of the invention provides a controller, which comprises:

a) a data collector operable to collect Network State at the at least two Layers;

b) a Reinforcement Deriver operable to deduce a scalar (discrete or continuous) Reinforcement Signal from the Network State;

c) a data processor operable to process the Network State and the Reinforcement Signal to determine that a Network Adjustment is favourable, and to determine a favoured Network Adjustment; and

d) a reconfiguration initiator operable to initiate implementation of the favoured Network Adjustment.

The data processor can process Network State as a Reinforcement Learning agent using information from the at least two network Layers in the form of Fuzzy Logic variables to determine that a Network Adjustment of the at least two Layers is favourable. The Learning Agent can use Temporal Difference algorithms to optimise its policies and refine its decision-making process.

In one embodiment of this invention, fuzzy observations

xₜ=(x₁,x₂,x₃ . . . x_{M(L)})ₜ (1)

are received from each of the L>1 Layers of the network, xᵢ representing the fuzzified reading from the ith of the M(L) observation points in that Layer.

More formally, the invention sees the telecommunications network having L>1 Layers as a discrete-time, stochastic, dynamic system, observed from M(L) observation points and influenced by K(L) control stations in layer L as follows:

x_{t+δt}=fₜ(xₜ, uₜ, vₜ)

yₜ=gₜ(xₜ, wₜ) (2)

$$reinforcement = {\sum }_{t} {h}_{t} ( {x}_{t} , {u}_{t} ) \qquad ( 3 )$$

where:

xₜ is the observation vector at time t.

uₜ is the K-dimensional vector of actions chosen at time t

yₜ is the M-dimensional vector of observations taken at time t

item vₜ and wₜ are random disturbances (link failures, etc).

In one preferred embodiment of the invention, the highest Layer service is a packet data service, for example an Internet Protocol (IP) service, and the lower Layers of the network supporting the IP service include an optical transport layer including rapidly reconfigurable optical cross-connects. In this embodiment, one aspect of the invention provides a controller for controlling a communications network supporting a packet data service and zero or more Layer 2 services. The communications network has an optical transport layer below a packet data layer. The method comprises collecting data characterising activity of the network at both the packet data layer and the optical transport layer. The method further comprises processing the collected data to determine that:

a reconfiguration of the optical transport layer is favourable, and to determine a favoured reconfiguration of the optical transport layer; or

that requested customer demands should be met or rejected.

The method further comprises initiating implementation of the favoured reconfiguration and the acceptance or rejection of the customer demands.

In this embodiment, rapid reconfiguration of the optical transport Layer according to data collected from both the packet data layer and the optical transport Layer reduces over-provisioning of the network needed to meet difficult-to-predict traffic patterns and loss of revenue due to inability to serve traffic with the current network configuration.

In another aspect of the embodiment a node is provided for a communications network. The node comprises a router for routing data packets, a cross-connect switch connected to the router for configuring transmission links connected to other nodes, and a configuration controller connected to the router and to the cross-connect switch for controlling configuration of the transmission links. The configuration controller is operable to collect data characterising activity of the network and user demandat both the router and the cross-connect switch, to process the collected data to determine that:

a reconfiguration of the transmission links is favourable and to determine a favoured reconfiguration of the transmission links; and

particular customer demands should be met or rejected and to initiate implementation of the favoured reconfiguration and call admission decisions.

In a further embodiment, the configuration controller may comprise functionality which is integrated with the router, functionality which is integrated with the cross-connect switch, functionality which is separate from the router and the cross-connect switch or any combination of the above.

Another aspect of the embodiment provides a communications network for providing a Layer 1, Layer 2 and Layer 3 service. The network comprises a plurality of interconnected network nodes.

In this embodiment, the configuration controller may comprise centralized functionality which is connected to multiple nodes of the network, or may comprise functionality which is distributed among at least some of the nodes, or may comprise a combination of centralized and distributed functionality.

In a further embodiment a method is provided for controlling a communications network supporting a Layer 3 service, the communications network having at least one Layer below Layer 3 supporting the Layer 3 service. The method comprises collecting data characterizing activity of the network at both Layer 3 and at the at least one Layer below Layer 3. The method further comprises processing the collected data to determine that a reconfiguration of the at least one Layer below Layer 3 is favourable, and to determine a favoured reconfiguration of the at least one Layer below Layer 3. The method further comprises initiating implementation of the favoured reconfiguration.

The step of collecting data may comprise collecting data characterizing activity of a local subnetwork at both Layer 3 and at the at least one Layer below Layer 3. The step of processing the collected data may comprise processing the collected data to determine that a reconfiguration of the local subnetwork at the at least one Layer below Layer 3 is favourable, and to determine a favoured reconfiguration of local subnetwork at the at least one Layer below Layer 3. The step of initiating implementation of the favoured reconfiguration may comprise initiating reconfiguration of the local subnetwork.

The method may further comprise collecting data characterizing activity of a larger network containing the local subnetwork at both Layer 3 and at the at least one Layer below Layer 3, processing the collected data to determine that a reconfiguration of the larger network at the at least one Layer below Layer 3 is favourable, and to determine a favoured reconfiguration of larger network at the at least one Layer below Layer 3, and initiating reconfiguration of the larger network.

The local subnetwork reconfigurations can be achieved relatively quickly to respond to rapid local fluctuations in traffic patterns. The slower reconfigurations of the larger networks may lead to more optimum results over the long term.

Yet another aspect of the invention provides a method of designing or extending networks using anticipated customer demand and equipment failure rates. In this embodiment the Configuration Manager operates without a real network or with only a small portion of an intended network. By making use of the anticipated customer demand combined with the real customer demand from that part of the network which may exist, the Configuration Manager can be used to determine an economic placement of links and devices to create or extend a network.

### BRIEF DESCRIPTION OF DRAWINGS

Embodiments of the invention are described below by way of example only. Reference is made to accompanying drawings, in which:

FIG. 1 is a block schematic diagram of a communications network according to an embodiment of the invention;

FIG. 2 illustrates the main local interfaces provided by a Configuration Manager (CM);

FIG. 3 is a flow chart illustrating operation of a Configuration Manager (CM) of the network of FIG. 1 according to an embodiment of the invention;

FIG. 4 is a block schematic diagram showing the internal structure of the controller shewn as 116, 126, 136, 146 and 160 in FIG. 1;

FIG. 5 illustrates the definition of a Fuzzy Logic variable used in the operation of the CM;

FIG. 6 is a block diagram of the Actor/Critic Control Mechanism;

FIG. 7a is a block diagram of a sample node; and

FIG. 7b is an illustrative example of a sample network.

### DETAILED DESCRIPTION OF EMBODIMENTS

In order to lighten the description of the embodiments, the following accronyms will be used throughout this specification:

| | |
|---|---|
| ATM | Asynchronous Transport Mode |
| CM | Control Manager |
| CMAC | Variously “Cerebellar Model Articulation Controller” or |
| Model | “Cerebellar Arithmetic Computer” |
| IP | Internet Protocol |
| MPLS | Multi-Protocol Label Switching |
| OXC | Optical Cross-Connect |
| SDH | Synchronous Digital Hierachy |
| SLA | Service Level Agreement |
| SONET | Synchronous Optical Network |
| WDM | Wavelength Division Multiplexed |

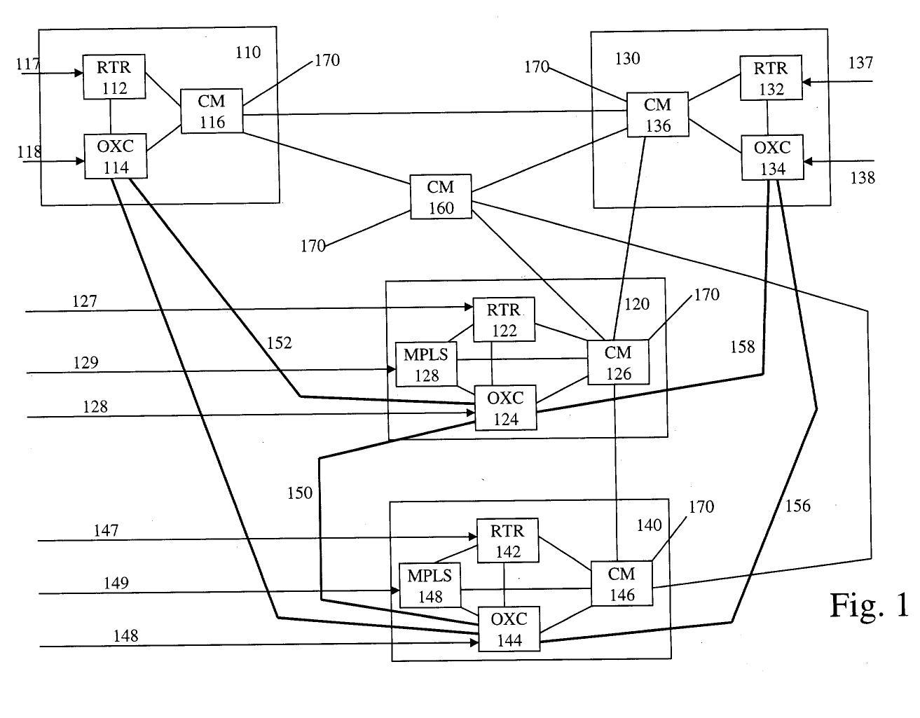

FIG. 1 is a block schematic view of a communications network 100 that supports services at more than one network Layer. In FIG. 1, Layer 3 services, such as Internet Protocol (IP) services, Layer 2 services such as ATM or MPLS and layer 1 services such as switched optical connections, switched fibres or switched Wavelength Division Multiplexed channels are shown according to an embodiment of the invention. The network 100 comprises a plurality of nodes 110, 120, 130, 140 interconnected by transmission links 150, 152, 154, 156, 158. Nodes variously comprise a Layer 3 device 112, 122, 132, 142, a Layer 2 device 128, 148, a layer 1 device 114, 124, 134, 144, and CMs 116, 126, 136, 146.

Each Layer 3 device 112, 122, 132, 142 may be connected to customer equipment 117, 127, 137, 147 from which customer demands may arise and may be connected to its respective lower Layer services on which it relies 114, 124, 134, 144, 128, 148.

Each Layer 2 device 128, 148 may be connected to some of the Layer 1 devices 124, 144 and may provide service for higher Layers 122, 142 and for customer equipment 129, 149.

Each Layer 1 device 114, 124, 134, 144 may be linked by WDM optical transport systems 152, 154, 156, 158, each of which carries a plurality of wavelength channels to other Layer 1 devices. Each wavelength channel may be configured at an OXC 114 of a node 110 to add and drop traffic, or to pass through that node 110 without adding and dropping traffic. Each Layer 1 device 114, 124, 134, 144 will normally be configured to add and drop traffic from some wavelength channels and to pass through other wavelength channels without adding and dropping traffic from those channels. In addition to providing services for the higher Layer devices 112, 122, 128, 132, 142, 148, each Layer 1 device may also provide services for customer equipment 118, 128, 138, 148.

The Layer 3 devices 112, 122, 132, 142, Layer 2 devices 128, 148 and Layer 1 devices 114, 124, 134, 144 at each node are connected to a respective CM 116, 126, 136, 146 at that node. Each CM is connected to the CMs of the other nodes and possibly to a higher level CM 160. In a large system there may be several layers of CMs. The CM 126 at node 120 receives traffic and customer demand data from its respective Layer 3 device 122, receives current configuration data and customer demand from its respective Layer 2 device 128, receives current configuration data and customer demand from its respective Layer 1 device 124 and from the CMs 116, 136, 146 at other nodes 110, 130, 140, and controls the configuration Layer 2 paths at its respective Layer 2 device 128 and controls the configuration of wavelength channels at its respective Layer 1 device 124. The CMs 116, 136, 146 at the other nodes 110, 130, 140 perform like functions at their respective nodes.

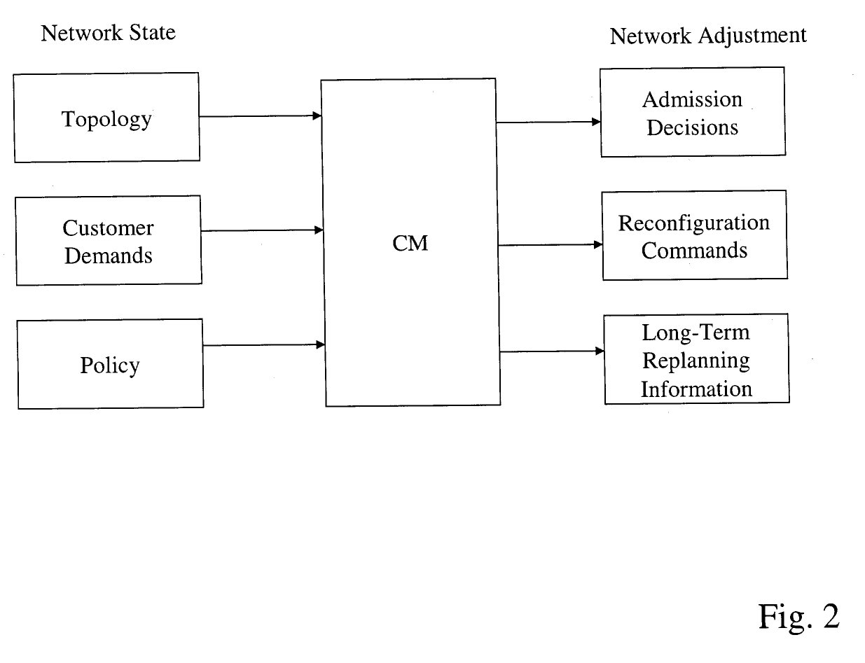

FIG. 2 shows the primary interfaces to the CMs 116, 126, 136, 146 and 160. The elements of Network State are accepted and the elements of Network Adjustment are emitted. Note that both the Network State and the Network Adjustment refer to all Layers of the network.

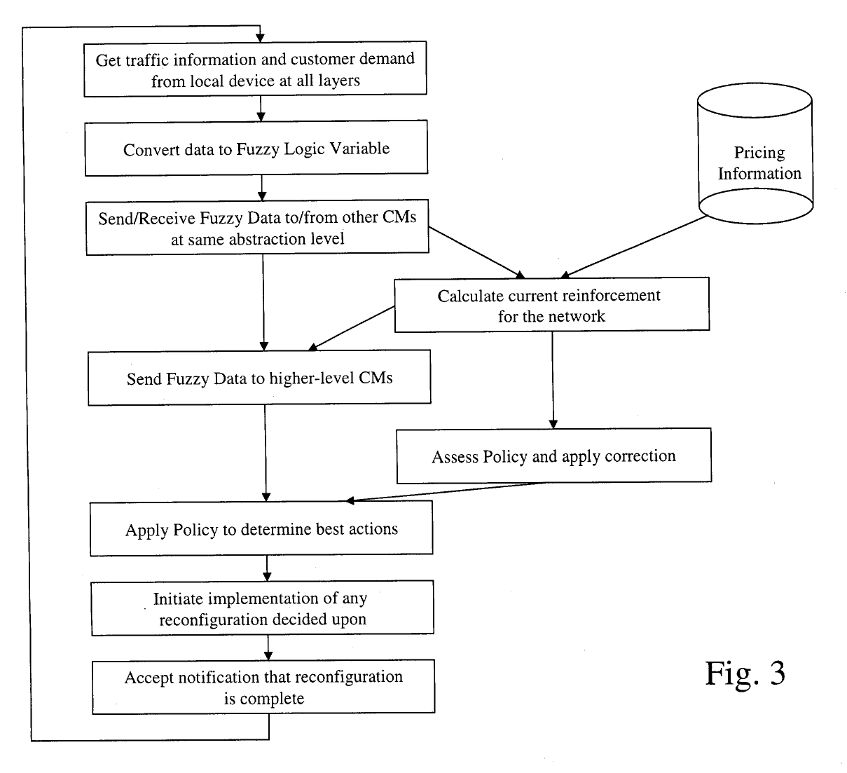

FIG. 3 is a flow chart 200 illustrating the operation of each CM 116, 126, 136, 146 according to an embodiment of the invention. The operation of a higher-level CM 160 is similar except that information is received not directly from network devices but from other, lower-level CMs and is already in Fuzzy Variable form.

Each lowest-level CM obtains information from its local devices at its node regarding customer demands and current device status. For layer 3 devices, the status could include a LinkLoading % for each link terminated on the device, a DiscardRate % for each link terminated on the device, and a Variance Coefficient characterizing the normalized variance of the queue length for each link terminated on the device. For Layers below Layer 3 the status could include a Utilisation % for each outgoing link, path or tunnel and the Reject % for burst calls.

For reasons of data compression and algorithm stability, these values may be converted to Fuzzy Logic variables as illustrated in FIG. 3. Note that the actual shapes of the Fuzzy Sets shown in FIG. 3 are illustrative only as they are adjusted dynamically to ensure optimal separation of the useful network states.

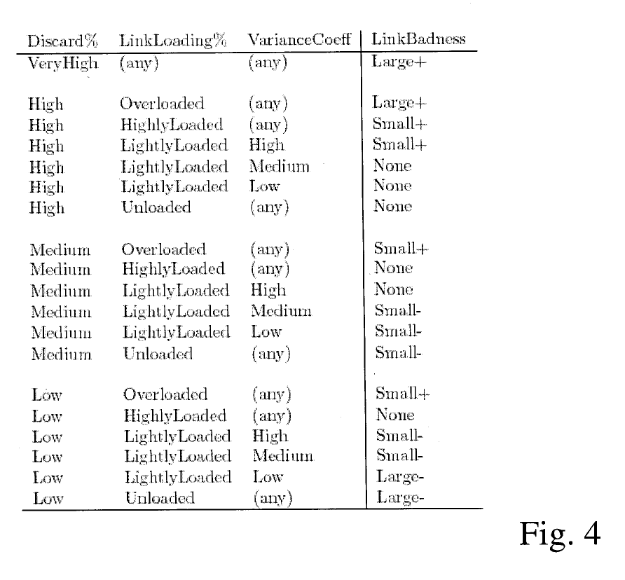

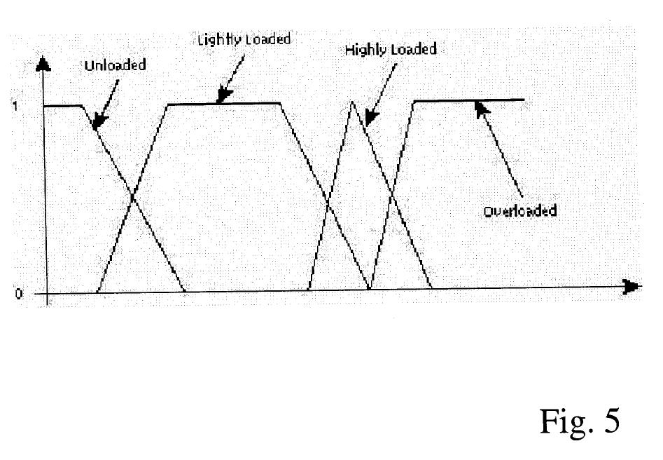

For each Layer, each CM then further compresses the data by computing, for example, a LinkBadness variable for each link terminated on the device by applying Fuzzy Logic Rules as illustrated in FIG. 4 to the LinkLoading %, DiscardRate % and VarianceCoefficient variables described above. Similar compression is achieved for other combinations of variables. FIG. 5 illustrates the definitions used for Fuzzy Logic variables used in the operation of the CM.

Each CM maintains a current map of resources allocated to services at each of the at least two Layers.

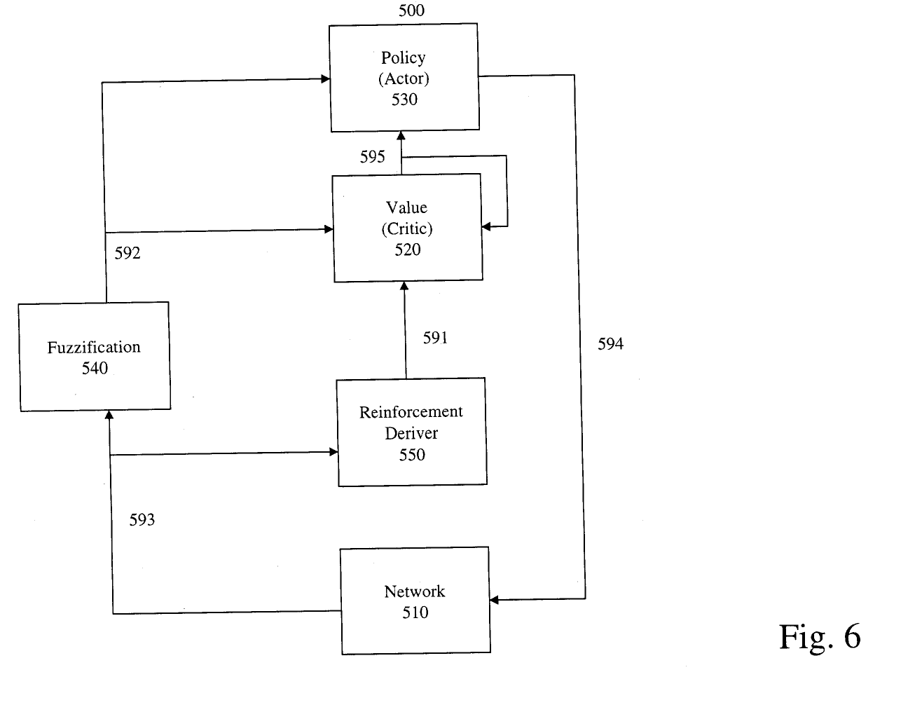

FIG. 6 shows the internal structure 500 of each lowest-level CMs 116, 126, 136 and 146 in FIG. 1. As described above, the network devices 510 provide information to the CM 593. This information is fuzzified 540 as described above to provide a composite state of the network with at least two Layers of Network 592. The device information 593 is also used, either internally to the CM 550 or by an external device provided by the network owner, to derive a Reinforcement signal 591 which is fed to a Temporal Difference Engine 591 acting as a “critic”. This critic calculates the difference between the anticipated reaction of the network to the previous actions of the CM in accordance with a calculation of the form:

δₜ=rₜ₊₁+γV(sₜ₊₁)−V(sₜ) (4)

where δₜ is the (signed) error, γ is a constant chosen for the particular application, rₜ₊₁ is the reinforcement signal 591 received at time t+1 and V(s) is the current estimation of the value of the possible actions to be made to the network when it is in state s. In the invention V (sₜ) maybe held as a table, but in realistic networks this is impractical and a multi-dimensional functional approximator such as a CMAC is used.

The error signal δₜ is provided 595 to the actor 530 which also has access to the fuzzified state of the at least two Layers of network 592. The actor uses a conventional mechanism to determine the appropriate action given the fuzzified state 592. Such mechanisms are well-known in the literature and include the ε greedy method (select the currently optimal action for a fraction 1−ε of the time and a random action for a fraction \epsilon of the time for a small ε) and the Gibbs softmax method

$$Pr \{ {a}_{t} = a \vert {s}_{t} = s \} = \frac{{ⅇ}^{p ( s , a )}}{{\sum }_{b} {ⅇ}^{p ( s , b )}} \qquad ( 5 )$$

In the case of the Gibbs softmax method, the value of p(s,a) is altered by the error signal 595 to strengthen the probability of selecting an action with a favourable outcome or weaken the probability of selecting an action with an unfavourable outcome in accordance with a calculation of the form

p(sₜ, aₜ)=p(sₜ, aₜ)+βδᵢ (6)

for some constant β chosen for the application.

Having selected an action, the actor 530 applies the action to the network 594 and the cycle repeats.

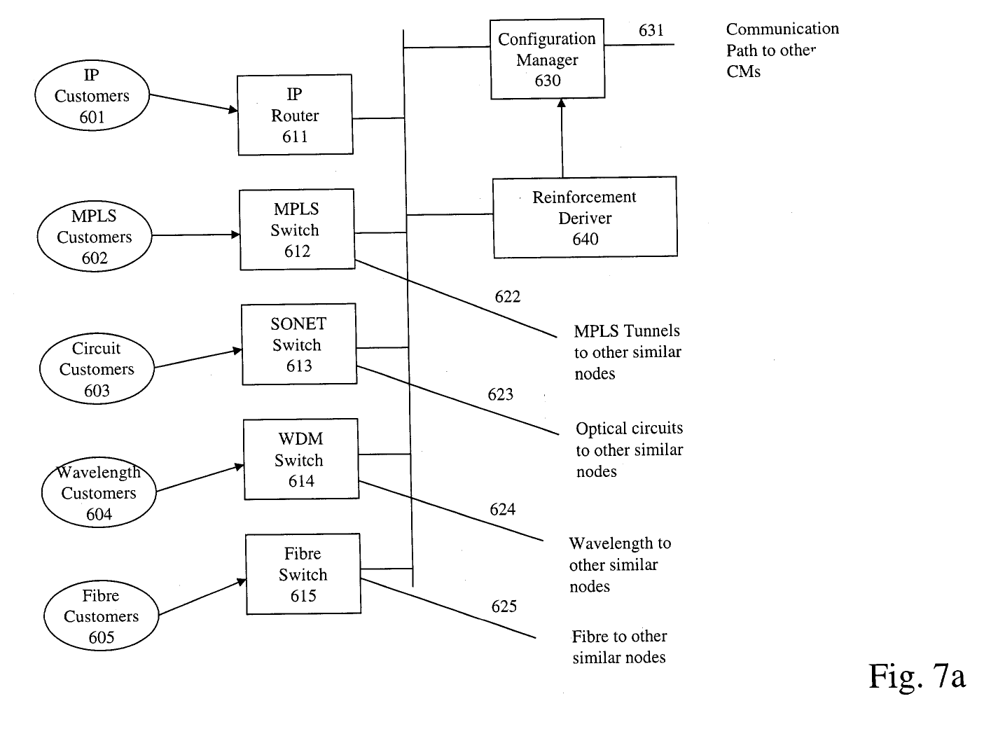

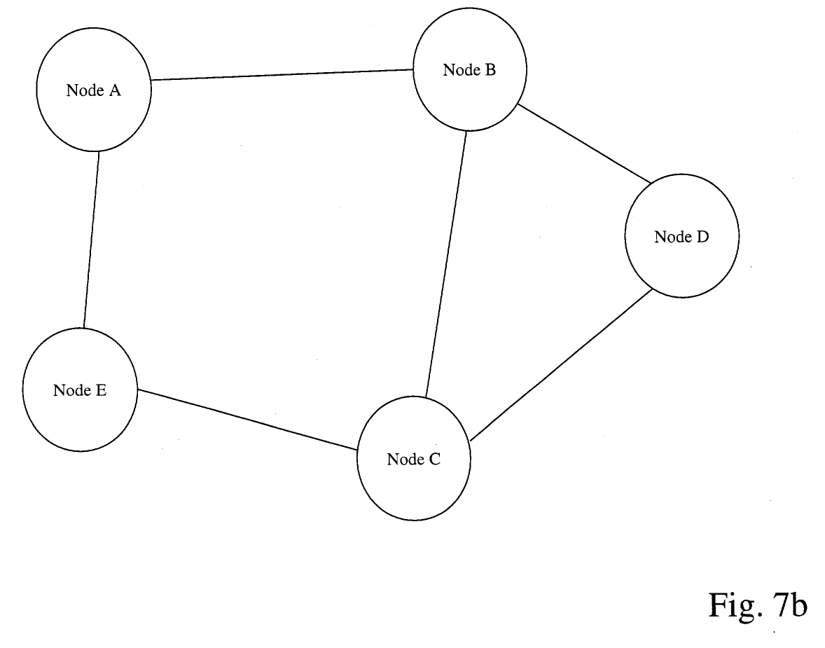

FIGS. 7a and 7b show details of one particular embodiment. Each node in the example of FIG. 7b has the general structure illustrated in FIG. 7a and comprises:

1. devices 611, 612, 613, 614 and 615 which operate at five different network levels.

Device 611 is an IP Router which makes use of the underlying MPLS switch 612 to establish tunnels to other routers in the network to allow it to route packets on behalf of IP Customers 604.

Device 612 is an MPLS switch which handles traffic from the IP Router 611 and from MPLS Customers 602 who buy a tunnelling service. Device 612 has to allocate resources to traffic from both these sources and makes use of the underlying SONET or SDH optical switch 613 to establish connectivity to other MPLS switches.

Device 613 is a SONET or SDH optical switch capable of establishing and tearing down circuits on demand. It has to allocate resources to traffic from the MPLS switch 612 and from Circuit Customers 603 who buy a conventional SONET or SDH service. Device 613 makes use of the underlying Wavelength Division Multiplexing (WDM) switch 614 to establish connectivity to other SONET or SDH optical switches.

Device 614 is a WDM switch capable of rerouting wavelengths on demand, possibly incorporating a wavelength conversion capability. It has to allocate resources to traffic from the SONET or SDH layer 613 and from Wavelength Customers 604 who buy a transparent wavelength service. Device 614 makes use of the underlying Fibre Switch 615 to establish connectivity to other WDM switches.

Device 615 is a Fibre switch capable of rerouting fibres on demand. It has to allocate resources to traffic from the WDM layer 614 and from Fibre Customers 605 who buy a transparent fibre service.

2. the Reinforcement Deriver 640 (also 550) which has access to information from the devices 611, 612, 613, 614 and 615 and which can calculate the current worth of the network to the network provider and give this as a reinforcement signal to the Configuration Manager 630.

3. the Configuration Manager 630 which has access to network status information and customer demands from each of the devices 611, 612, 613, 614 and 615 and a Reinforcement signal from the Reinforcement Analyser 640.

FIG. 7b contains a simple representative network which is used here for illustrative purposes. Note that the example given in FIG. 7b is very simplified. In reality, there are likely to be more complex relationships between the devices 611, 612, 613, 614 and 615. In particular, device 611 may make direct use of devices 612, 613 and 614 for different traffic types. There are likely to be significantly more nodes in a network than is shown in FIG. 7b. The Configuration Manager 630 may not be present in all nodes. Several layers of the CM may be present in some nodes.

The above description illustrates how embodiments of the invention collect data from the at least two Layers of the network including, where appropriate, the packet layer (Layer 3), any connection-oriented layers (Layer 2) and the transport layers (Layer 1) to sense traffic demand, existing traffic patterns and existing topological constraints. A policy for selecting suitable reconfiguration of lower Layers and acceptance or rejection of requested calls is created and continually refined through the use of Reinforcement Learning making use of a Temporal Difference algorithm. The resulting recommendations may be applied automatically to the network through a control interface or may be provided as advice to an operator.

Features of the embodiments described above may be modified without departing from the invention as broadly defined in the claims below.

For example, the LinkBadness Fuzzy Variable can be defined to include weighted components characterizing both the current operating point and the current trend of traffic parameters characterizing the congestion of the link.

The CMs 116, 126, 136, 146 could collect the LinkLoading %, DiscardRate %, VarianceCoeff data from the Layer 3 devices 112, 122, 132, 142, the LinkLoading %, DiscardRate %, VarianceCoeff data having been computed from more basic traffic data at the Layer 3 devices 112, 122, 132, 142. Alternatively, the CMs 116, 126, 136, 146 could collect the more basic traffic data from the Layer 3 devices 112, 122, 132, 142 and process those data at the CMs 116, 126, 136, 146 to compute the LinkLoading %, DiscardRate %, VarianceCoeff data.

Alternative embodiments could use other Fuzzy Variables or more Fuzzy Variables, for example variables characterizing revenues generated by the links.

The following variables could be used alone or in various combinations:

1. accepted traffic discarded in network(as in the embodiment described above);

2. traffic refused at ingress;

3. use of high cost links (e.g. via other provider);

4. broken Service Level Agreements (SLAs);

5. traffic delivered beyond requirements of SLAs (supererogation);

6. cost or revenue loss attributable to any of above.

In a large network, the policies determined by the Temporal Difference methods described above could be computed for a local subnetwork and reconfiguration could be implemented within the local subnetwork on a relatively frequent basis to improve the operation of the local subnetwork. More global computation of reconfiguration can be computed over a larger subnetwork or over an entire network less frequently to improve operation of the larger network by a higher-level CM 160 using information received from the lower-level CMs 116, 126, 136, 146. Because the signalling and computations required for reconfiguration of the larger network necessarily take longer, reconfiguration confined to smaller local subnetworks can be advantageous where rapidly changing traffic patterns require rapid reconfigurations.

The location of the CM functionality described above need not necessarily be isolated from other network functionality as described above. The implementation of the CM functionality at each node could be integrated into any of the devices at any Layer in the node or could be distributed between the devices at a node. Some or all of the CM functionality could also be centralized, but this could impose limits on speed of reconfiguration, so that reconfiguration capabilities may not be adequate for some applications, e.g. protection switching.

From this view, the invention attempts to find a stochastic policy for each of the K control points which will maximize the network-owner's profits.

This representation has been chosen to make its mapping to the Temporal Difference algorithms straight-forward to one skilled in the art.

Using Reinforcement values that relate directly to profits offers network providers the potential of controlling their networks in a manner which is tailored to revenue generation.

In particular, the state variables may comprise variables selected from the group consisting of:

1. Network Topology.

the current availability of links, paths and connexions at each of the at least two Layers;

the current loading of physical links (percentage of total capacity being used); the cost of revenue loss attributable to any of:

i.accepted traffic discarded in network (in a packet network this might represent packets discarded because of congestion at intermediate nodes; in a burst switching circuit network this might represent data discarded because a circuit could not be established onward at an intermediate node);

ii.traffic refused at ingress (in a circuit network this might represent the refusal of the network provider to establish a circuit requested by a customer);

iii.the current use of high cost links (in a circuit network this might represent using a competitor's circuits or an expensive satellite circuit instead of a cable);

iv.broken Service Level Agreements; and

v.traffic delivered beyond requirements of SLAs.

2. Customer Demands.

actual demands made by customers for connexions at any of the at least two Layers;

predicted customer demands, the predictions being based on previous behaviour (e.g. a customer always requiring a particular circuit on Tuesday afternoons) or scheduled events (e.g. international cricket match).

3. Policy.

policy related to the treatment of demands made by a particular customer (e.g. if physical resources exist then demands made by Company X shall always be met irrespective of the anticipated gain or loss);

policy related to the use of competitors' networks when insufficient resources exist in the provider's own network.

The reconfiguration initiator may be operable to initiate Network Adjustments selected from the group consisting of:

1. Admission Decisions:

Acceptance or rejection of actual customer demands for resources.

2. Reconfiguration Commands.

Reconfiguration of:

physical links of the network (for example, fibres, cables or radio links);

WDM channels of the network, including any necessary wavelength conversion;

SONET/SDH paths;

virtual paths of network;

irtual channels of network; and

label switched paths.

3. Long-Term Planning Information.

Emission of information relating to the costs and benefits which could accrue from the installation or removal of physical links.

It should be noted that, as the full network state cannot be gathered and transmitted, the invention works on a Partially-Observable Markovian Decision Process (POMDP) and, strictly speaking, is therefore not a state vector but a vector of observations of the state. In addition, a scalar Reinforcement Signal is generated (or received from the network or the network operator's management equipment) representing the profit being derived from the at least two Layers.

Given a current Network State the invention uses the method of Temporal Difference to choose an action which maximizes the network owner's future profits. By the selection of the numerical value of certain parameters as described in the general literature (see, for example, “Reinforcement Learning” by Sutton and Barto, MIT Press, 1999) it is possible to tune the algorithm to maximize shorter or longer-term gains and it is anticipated that the network provider would customize such a system to orient it towards selecting policies which meets his business needs.

The features and modifications described and illustrated above may be combined in subcombinations and arrangements other than those described and illustrated above, depending on what benefits of the above embodiments are required for a particular application.

We claim:

1. A controller for controlling a communications network providing services at least two Layers, the controller comprising:
a data collector operable to collect data characterizing demand and activity of the network at at least two Layers;
a reinforcement operable to determine a scalarReinforcement signal from the data characterizing the network at least two Layers;
a data processor operable to process the collected data to determine whether customer demands should be met and whether a reconfiguration of at least one Layer is favourable, and to determine a favoured reconfiguration of the at least one Layer; and
a reconfiguration initiator operable to initiate implementation of the favoured reconfiguration to initiate the acceptance or rejection of incoming customer demands.

2. A controller as defined in claim 1, wherein the reconfiguration initiator comprises a transmitter operable to transmit at least one signal to network elements of the at least one Layer to initiate implementation of the favoured reconfiguration.

3. A controller as defined in claim 1, wherein the data processor is operable to process one of the collected data collected as Crisp or Fuzzy Logic variables combining these if required according to a policy in the form of Fuzzy Logic rules, and the Reinforcement signal and the collected Fuzzy or Crisp variables to determine that a reconfiguration of at least one of the at least two Layers is favourable.

4. A controller as defined in claims 3, wherein the data processor is operable to process the the Reinforcement signal and the collected Fuzzy or Crisp variables to determine a favoured reconfiguration of the at least one of the at least two Layers.

5. A controller as defined in claims 3, wherein the reconfiguration initiator is operable to reconfigure the at least one of the at least two Layers.

6. A controller as defined in claims 3, wherein the data processor is operable to process the Reinforcement signal and the collected Fuzzy or Crisp variables to determine whether customer demands on resources at the at least two Layers should be met or rejected.

7. A controller as defined in claims 3, wherein the reconfiguration initiator is operable to instruct the one or more Layers of the network to accept or reject incoming customer demands for resources.

8. A controller as defined in claims 3, wherein the data processor is operable to modify its policy dynamically as a result of observing a Reinforcement ignal derived directly or indirectly from the network which indicates the quality of the reconfiguration and admission decisions previously made.

9. A controller as defined in claim 8 where the Reinforcement signal can assume two or more discrete values.

10. A controller as defined in claim 8, wherein the data processor is uses Reinforcement Learning techniques to process collected data collected as Crisp or Fuzzy Logic variables.

11. A controller as defined in claim 10, wherein the data processor uses Temporal Difference techniques to determine the policies to apply.

12. A controller as defined in claim 11, wherein the data processor uses a CMAC to store the derived policy.

13. A controller as defined in claims 3, wherein the Fuzzy Logic variables comprise variables selected from the group consisting of:
accepted traffic discarded in network;
traffic refused at ingress;
use of high cost links;
broken Service Level Agreements (SLAs);
traffic delivered beyond requirements of SLAs; and
cost or revenue loss attributable to any of:
accepted traffic discarded in network;
traffic refused at ingress;
use of high cost links;
broken Service Level Agreements (SLAs);
traffic delivered beyond requirements of SLAs;
traffic demands to establish a connection; and
traffic demands to deliver datagrams.

14. A controller as defined in claim 1, wherein the reconfiguration initiator is operable to initiate reconfiguration of links at one or more Layers selected from the group consisting of:
physical links of the network;
wavelength division multiplexing subchannels;
SONET/SDH paths;
virtual paths;
virtual channels; and
label switched paths.

15. A method for controlling a communications network supporting a packet data service, the communications network having an optical transport layer below a packet data layer, the method comprising:
collecting data characterising activity of the network and customer traffic demands at both the packet data layer and the optical transport layer;
processing the collected data to determine that a reconfiguration of the optical transport layer is favourable, and to determine a favoured reconfiguration of the optical transport layer;
initiating implementation of the favoured reconfiguration;
determining whether incoming customer demands at both the packet data and optical transport layer should be met; and
initiating acceptance or rejection of customer demands at both the packet data and optical transport layers.
